(19) United States
(12) Patent Application Publication
(10) Pub. No.: US 2023/0068013 A1
(43) Pub. Date: Mar. 2, 2023

(54) TOOLING SYSTEM AND METHOD OF MAKING A PLUG

(71) Applicant: TALLY USA, LLC, Houston, TX (US)

(72) Inventor: Douglas DAVISON, Canyon Lake, TX (US)

(21) Appl. No.: 17/899,931

(22) Filed: Aug. 31, 2022

Related U.S. Application Data
(60) Provisional application No. 63/239,051, filed on Aug. 31, 2021.

(51) Int. Cl. E21B 33/12; B24C 1/04; B26F 3/00

(52) U.S. Cl. CPC E21B 33/1208; B24C 1/045; B26F 3/004

(57) ABSTRACT

Embodiments presented provide for a slip wedge anchor system that is used in plugs for hydrocarbon recovery operations, wherein the plugs are made through a sacrificial tooling element.

### CROSS-REFERENCE TO RELATED APPLICATIONS

This application is a nonprovisional application which claims priority from U.S. provisional application No. 63/239,051, filed Aug. 31, 2021, which is incorporated by reference herein in its entirety

### FIELD OF THE DISCLOSURE

Aspects of the disclosure relate to plugs used in hydrocarbon recovery operations. More specifically, aspects of the disclosure relate to an anchoring system for plugs that use a slip wedge arrangement. Other aspects relate to methods of manufacturing plug systems.

### BACKGROUND

Hydrocarbon recovery operations may take many forms. Over time, these operations have evolved to allow for economical recovery of hydrocarbons from available resources. To achieve this economical recovery, many different types of tools may be employed by field personnel to conduct efficient operations. These operations may include recovery of natural gas, oil and/or mixtures of natural gas and oil.

Past conventional recovery operations were simple from a technical perspective. A drill rig was placed over a hydrocarbon bearing field (oil reservoir). The drill rig was activated and a drill string was created to drill down to the oil reservoir. Once penetrated, the oil reservoir was extracted through either its own inherent pressure or through pumping the oil up through the drill string.

As time has progressed, conventional oil fields that have been discovered have been much smaller compared to earlier times. As the need for oil has increased over time, new technologies are required to meet industry needs for extracting oil from these smaller reserves.

One new source for oil is found in shale fields. Shale fields contain hydrocarbons that may be recovered using a variety of technologies. One of these technologies involves the process of hydraulic fracturing. To liberate hydrocarbons trapped within the shale, sections of a wellbore are sealed from other sections of the wellbore and a hydraulic fracturing fluid is pumped down to the sealed wellbore sections. Pressure is increased in the sealed wellbore sections until the hydraulic pressure breaks the wellbore casing and/or geological formation around those wellbore sections.

The broken geological formations are maintained in an open “cracked” configuration by pumping down sand or other granular type materials that lodge within the cracks, thereby preventing closure of the cracks. Hydrocarbons trapped in the geological formation are released due to the decreased pressure in the formations. The hydrocarbons are collected in the wellbore and pumped to an up-hole environment.

To section off portions of the wellbore in order to accomplish the hydraulic fracturing, plugs are used to wedge into predefined sections of the wellbore. While plugs have been used for many years, there are many drawbacks in such conventional designs.

Conventional plugs are expensive to produce. Multiple sections including wedges, rings, bearing surfaces must be finely machined to allow the plug to wedge within the wellbore. These multiple sections must be individually made and then assembled into a single unit.

As plugs are made to be one time use products, it is desirable to manufacture the plugs as inexpensively as possible. Due to the complexity of conventional plug designs, such plugs may fail to properly hold or deploy. Conventional apparatus have portions called a “slip ring”. These slip rings may be configured to break away into segments or, in other embodiments, are held together by components called “slip bands”. In operation, slips ride up the side of a cone shaped structure, pushing the slips out into the casing. The efficient manufacturing of plugs can have a significant impact on the overall cost of the produced plug. As plugs are “expendable” and consumed during hydrocarbon recovery operations, there is a need to minimize the overall costs of such plugs, thereby driving down the ultimate cost of services.

There is a need to provide an apparatus and methods that are easier to operate than conventional apparatus hydraulic fracturing plugs.

There is a further need to provide hydraulic fracturing plugs and methods using hydraulic fracturing plugs that do not have the drawbacks discussed above and that are easier to manufacture than conventional apparatus.

There is a still further need to reduce economic costs associated with operations and apparatus described above with conventional tools.

There is a further need to provide a method wherein a plug may be made such that the tooling element used may be advantageously reused to minimize costs of production of subsequent plugs.

There is a further need to provide a tooling element that may be used with conventional fabrication techniques used in plug manufacturing.

There is a still further need to provide a tooling element that is light weight and easily manipulated to allow for efficient plug manufacturing.

There is a still further need to provide a tooling element that will allow for winding operations used in composite plugs and that will allow for proper support and cooling of manufactured plugs.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method is disclosed. The method comprises providing a sacrificial tooling element. The method further comprises forming at least one component of a plug component on an exterior of the sacrificial tooling element. The method may further comprise forming an exterior source of the at least one component of the plug. The method may also comprise sacrificing at least a portion of the sacrificial tooling element. The method may also comprise removing the sacrificial tooling element from the at least one component.

In another example embodiment, a tool component is disclosed, comprising a cone, a first portion connected to the cone, and a sacrificial tooling portion connected to the first portion. The tool component may further comprise a second portion connected to the sacrificial tooling portion and a third portion connected to the second portion. The tool component may further comprise a second sacrificial portion connected to the third portion and a fourth portion connected to the second sacrificial portion. The tool component may further comprise a flange connected to the fourth portion.

In one example embodiment, a method is disclosed. The method may comprise providing a tooling element that is capable of disassembly. The method may also comprise forming at least one component of a plug component on an exterior of the tooling element. The method may also comprise disassembling the tooling element such that portions of the tooling element may be removed from the plug component. The method may also comprise removing each of the tooling elements from the plug component.

In another example embodiment, a method is disclosed. The method may comprise, providing a sacrificial tooling element and forming at least one component of a plug component on an exterior of the sacrificial tooling element. The method may also provide for sacrificing at least a portion of the sacrificial tooling element.

In another example embodiment, an arrangement, is disclosed. The arrangement may comprise a body having a longitudinal axis. The arrangement may be configured with a lower slip system located on the body, the lower slip system having at least a first set of six slips and at least six wedges configured to interact with a scalloped portion, wherein the slips are configured to shear from an associated wedge of the at least six wedges at a pre-determined shear force. The arrangement may also be configured with an upper slip system located on the body, having a taper, a second set of at least six slips and at least six wedges, the at least six wedges configured to interact with the taper, wherein the slips are configured to shear from an associated wedge of the at least six wedges at a pre-determined shear force.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not to be considered limiting of its scope, for the disclosure may admit to other equally effective embodiments.

FIG. 1 is a method for manufacturing a component of a frac plug through use of a sacrificial tooling element.

FIG. 2 is a side elevation view of a sacrificial tooling element in accordance with one example embodiment of the disclosure.

FIG. 3 is a side perspective view of an upper slip system with slips and wedge in accordance with one example embodiment of the disclosure.

FIG. 4 is a side view of the upper slip system of FIG. 3.

FIG. 5 is a side view of a lower slip system in one example embodiment of the disclosure.

FIG. 6 is a side view of an anchor in one example embodiment of the disclosure.

FIG. 7 is a method of manufacturing a plug using a removable tool, in one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure provide a plug that is configured to address drawbacks of conventional apparatus that have plagued the hydrocarbon recovery industry. Aspects of the disclosure provide for components called “slip segments”. These slip segments are independently anchored, meaning that each slip segment is considered an individual component. Setting of the slip segments may be accomplished through a setting tool or through a pumped or dropped actuation ball.

More specifically, aspects of the disclosure also provide for a method of production for components of plugs, including those with independently anchored slip segments. In embodiments, manufacturing is highly automated such that the slips and wedge are wound at the same time. Then, the remaining components of the plug may be machined as one system. In embodiments, the slips will shear away from the wedge from which it is attached during the setting sequence. Aspects of the disclosure provide for manufacturing that is applicable to both top and bottom slip configurations.

Methods of manufacturing provide for a sacrificial tooling system. In embodiments, the inner diameter of embodiments disclosed will be formed through the exterior portions of the sacrificial tooling system. In embodiments, portions of the plug will be manufactured around the sacrificial tooling system. After the portions of the plug have been created, then the sacrificial tooling is removed. In other embodiments, methods of manufacturing provide for a tooling system that allows for the plug to be made around the periphery of the tooling system. The tooling system may then be modified, such that the tooling system may be retrieved from the inside of the manufactured plug. Such modifications may include a spring loaded system that allows for retraction of components into the body of the tooling system. Other embodiments allow for disassembly of the tooling system, wherein individual components may be disconnected from other portions of the tooling system and thus removed from the interior of the created plug.

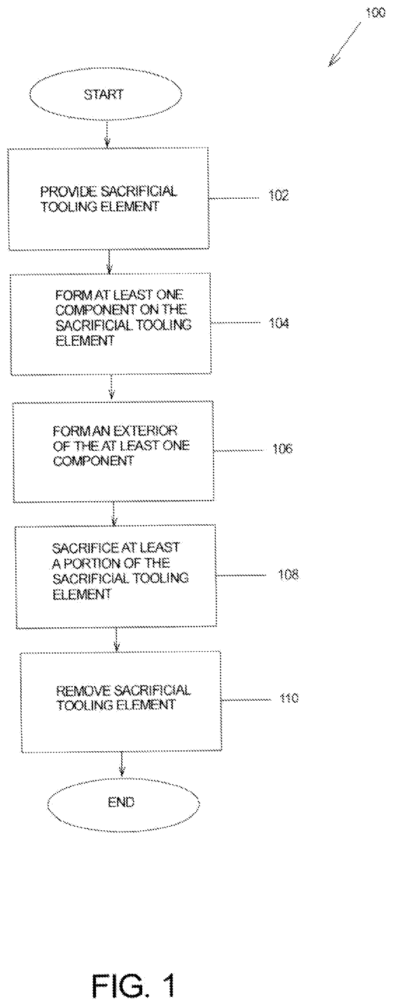

Referring to FIG. 1, a method 100 for production of a plug component is illustrated. In one embodiment, the method 100 may include providing a sacrificial tooling element at 102. At 104, at least one component of a plug component is formed on an interior surface of the at least one component of the plug around an exterior of the sacrificial tooling element. At 106, the method continues to provide for forming an exterior surface of the at least one component of the plug. In embodiments, the exterior surface may be a finalized exterior surface or the exterior surface may be a rough/unfinished exterior surface. At 108, the method may continue wherein the sacrificial tooling element is sacrificed to expose the interior surface of the at least one component of the plug. In one embodiment, the sacrificial tooling element may be removed by a high-pressure fluid injection process. This high-pressure fluid injection process may use water in one embodiment. In another embodiment, an acid may be used for the injection process. At 110, the method may continue wherein the sacrificial tooling element is removed from the at least one component.

As will be understood, the sacrificial tooling element may be made of several types of materials. In one example embodiment, the sacrificial tooling element may be made from a plastic or thermoplastic material. In other embodiments, the sacrificial tooling element may be made through the use of a three-dimensional printing apparatus.

In one embodiment, the sacrificial tooling element may have only a portion of the element made of material that may be sacrificed instead of an entire tool. Thus, a portion of the tool or portions of the tool may be made of sacrificial materials. In these embodiments, for example, the widest portions of the sacrificial tooling element may be made such that removal of the sacrificial material allows for removal of the remaining portions of the sacrificial tooling element. In other embodiments, the entire element may be sacrificed in order to remove the tool from the center of the plug.

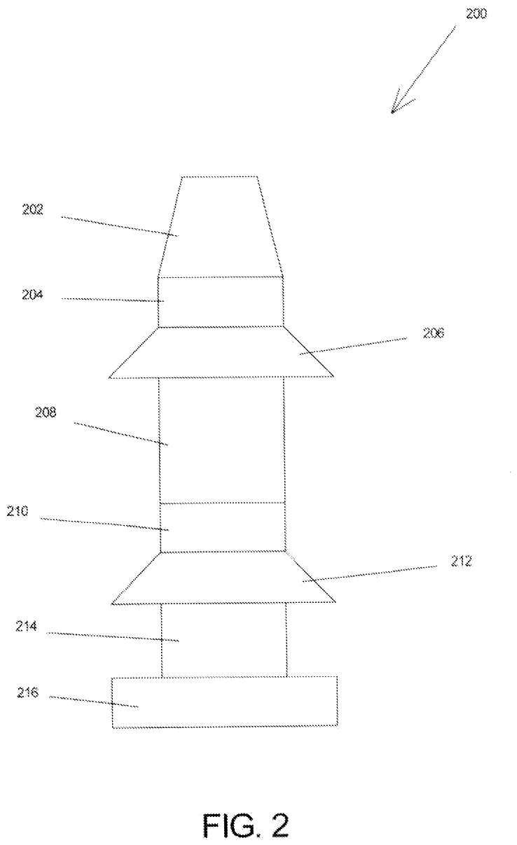

Referring to FIG. 2, a sample sacrificial tooling element 200 is illustrated. In this embodiment, the sacrificial tooling element 200 is provided with a cone 202 followed by a first portion 204. In this embodiment, the first portion 204 has parallel sides. The first portion 204 is followed by a sacrificial tooling portion 206. In this embodiment, the sacrificial tooling portion 206 may be an elongated tapered flange configuration. The sacrificial tooling portion 206 is followed by a second portion 208. The second portion 208 is connected to a third portion 210. The third portion 210 and the second portion 208, in this non-limiting embodiment, have parallel sides. A second sacrificial portion 212 is connected to the third portion 210. In this embodiment, the second sacrificial portion 212 is configured as an elongated tapered flange configuration with segments. The second sacrificial portion 212 may be connected to a fourth portion 214. The fourth portion 214 may be configured with parallel sides. The fourth portion 214 is connected to a flange 216.

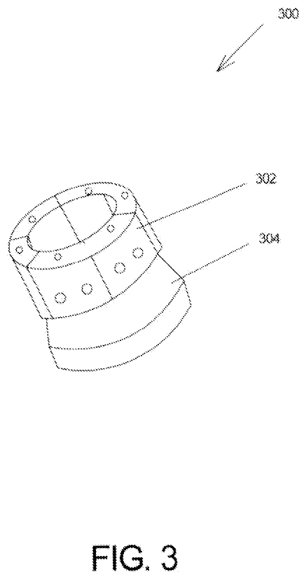

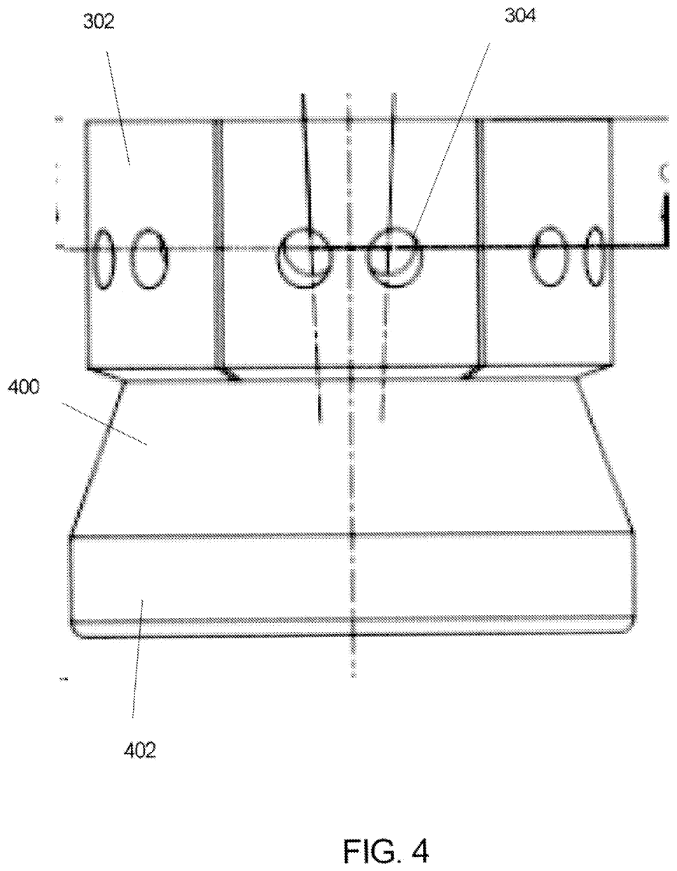

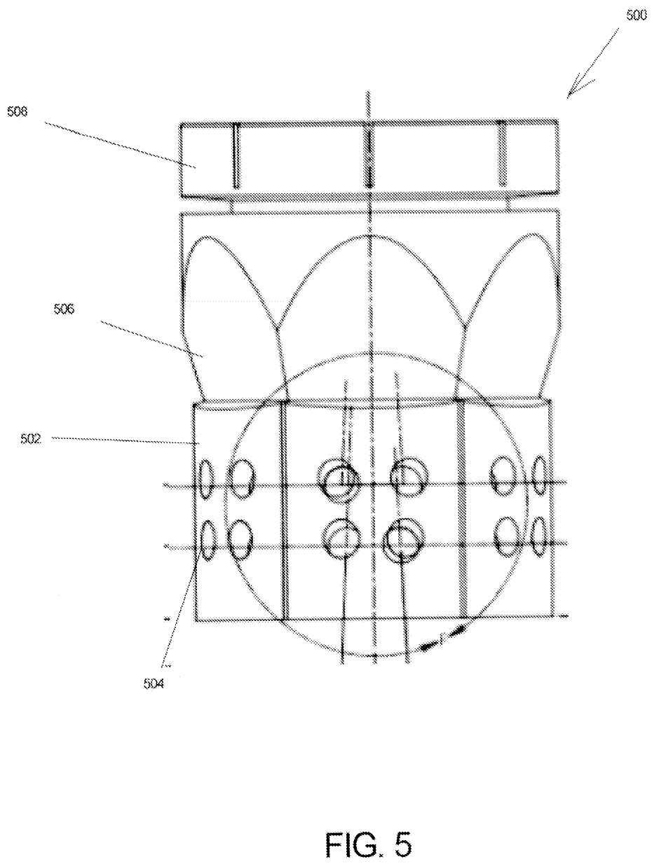

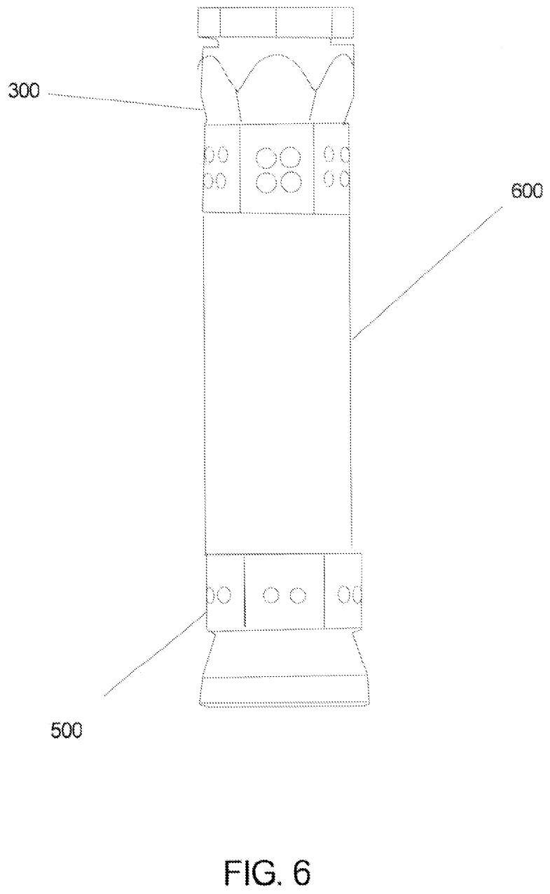

Referring to FIG. 3, a side perspective view of a slip and wedge assembly 300 is illustrated. Such slip and wedge assemblies 300 are used in a plug that has a longitudinal body, described in FIG. 6, as element 600. In this embodiment, individual slips 302 are provided. As illustrated, six (6) individual slips 302 are illustrated. Slips 302 interface with the wedge 304. In the illustrated embodiment, buttons are provided for each slip. The number of buttons per slip may vary. In some embodiments, a single button may be located on each slip 302. In other embodiments, three or more buttons may be used. The greater the number of buttons used, the greater the number of contact points established between the slip and casing once the plug is set. In embodiments, each of the slips 302 and the wedges 304 are manufactured at the same time. In one embodiment, the slips 302 and the wedges 304 are made of a composite material, such as a fiberglass mat, wherein the slips 302 and the wedges 304 are wound at the same time. During setting of the plug, a force is placed upon the longitudinal body, consequently actuating the slip and wedge assembly 300. The slip and wedge assembly 300 has an upper slip system (see FIG. 4) and a lower slip system (See FIG. 5), described below. As will be understood, the number of individual slips 302 and wedges 304 may be varied. To this end, at least one angled surface may be used, on either a slip 302 or a wedge 304 to make contact with a respective opposite component (slip or wedge) to make contact.

Referring to FIG. 4, a side view of the upper slip system portion of FIG. 3 is illustrated. In this side view, the slips 302 and the wedges 304 are illustrated as connected to a taper 400. The taper 400 is connected to an end section 402. In the illustrated embodiment, the slips 302 will shear away from the associated wedge 304 at a pre-determined shear force. The taper 400 may be configured wherein different amounts of taper may be shown. Differing angles of taper 400, as measured from a longitudinal axis of the slip and wedge assembly 300 are possible.

Referring to FIG. 5, a side elevation of a lower slip system 500 is illustrated. The lower slip system 500 has slips 502 and wedges 504 that function similarly to the slips 302 and wedges 304 described in FIG. 3 and FIG. 4. The lower slip system 500 is provided with a scalloped portion 506 that is connected to an end section 508. In embodiments, each of the slips 502 and the wedges 504 are manufactured at the same time. In one embodiment, the slips 502 and the wedges 504 are made of a composite material, such as a fiberglass mat, wherein the slips 502 and the wedges 504 are wound at the same time.

Referring to FIG. 6, a plug 600 is presented. The plug 600 is configured to be deployed into a wellbore such that the plug 600 may be lodged within the wellbore. The lodging of the plug 600 within the wellbore allows operators to hydraulically fracture geological formations adjacent to the wellbore sections separated by the plug 600. Multiple plugs 600 may be used or deployed within a single wellbore. Once deployed, each plug 600 is configured to friction fit inside the wellbore. Each plug 600 may have a lower slip system 500 and slip and wedge system 300 as previously described. The lower slip system 500 is the same as described in relation to FIG. 5. The upper slip system 300 is the same as described in relation to FIG. 3.

In another example embodiment, the plug 600 may be manufactured through the use of retractable tooling components. To this end, the plug 600 may be wound around a tool. The winding may be a glass material such as a fiber based component. After winding is complete, the tool may be removed through the use of retractable components. Such retractable components may be, for example, components that may slide or retract into an axis of the tool. In one embodiment, the components may be spring loaded and, upon actuation, retract into the axis of the tool. In other embodiments, the tooling may be more complex wherein the tool may be constructed in segments. Each of the segments may be configured to interlock with one another. These interlocking segments, however, may be configured to detach from one another, therefore successive pieces may be removed from the cavity of the plug 600. Thus, the tooling itself may be reusable in that the components of the tool may be reassembled to be used in construction of a new plug 600.

In embodiments, the tool may be made of a durable material, such as a stainless steel in embodiments where disassembly and reassembly of the tool is required. In embodiments, the tool may be segments, such as tongue and groove sections that allow other portions of the tool to be attached, as needed. Then, after forming the plug 600 around the tool, individual sections may be disconnected and removed.

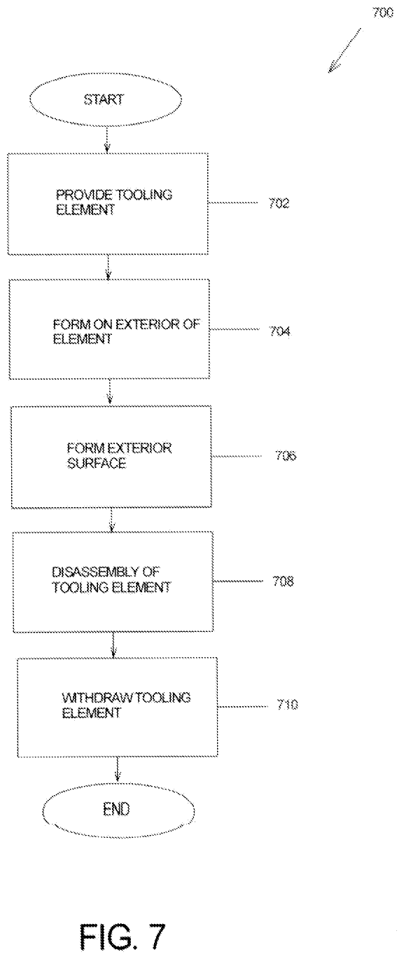

Referring to FIG. 7, a method 700 of making a plug is illustrated. The method 700 may be, for example, used to make a plug 600 as described earlier. The method may include In one embodiment, the method 700 may include providing a tooling element at 702. In this embodiment, the tooling element is a unit that may be disassembled. The disassembly may be through a tongue and groove system. The disassembly may also be accomplished through spring loaded action, where upon actuation, portions of the tooling element outside of the longitudinal axis of the tooling element collapse into the longitudinal axis of the tool. At 704, at least one component of a plug component is formed on an exterior of the tooling element capable of disassembly. At 706, the method continues to provide for forming an exterior surface of the at least one component of the plug. In embodiments, the exterior surface may be a finalized exterior surface or the exterior surface may be a rough/unfinished exterior surface. At 708, the method may continue with disassembly of the tooling element. At 710, the method may continue wherein each disassembled element of the tooling element is withdrawn from the plug.

Aspects of the disclosure provide an apparatus and methods that are easier to operate than conventional apparatus hydraulic fracturing plugs.

Aspects of the disclosure provide hydraulic fracturing plugs and methods using hydraulic fracturing plugs that do not have the drawbacks discussed above and that are easier to manufacture than conventional apparatus.

Aspects of the disclosure reduce economic costs associated with operations and apparatus described above with conventional tools.

Aspects of the disclosure provide a method wherein a plug may be made such that the tooling element used may be advantageously reused to minimize costs of production of subsequent plugs.

Aspects of the disclosure provide a tooling element that may be used with conventional fabrication techniques used in plug manufacturing.

Aspects of the disclosure provide a tooling element that is light weight and easily manipulated to allow for efficient plug manufacturing.

Aspects of the disclosure provide a tooling element that will allow for winding operations used in composite plugs and that will allow for proper support and cooling of manufactured plugs.

In one example embodiment, a method is disclosed. The method comprises providing a sacrificial tooling element. The method further comprises forming at least one component of a plug component on an exterior of the sacrificial tooling element. The method may further comprise forming an exterior source of the at least one component of the plug. The method may also comprise sacrificing at least a portion of the sacrificial tooling element. The method may also comprise removing the sacrificial tooling element from the at least one component.

In another example embodiment, the method may be performed wherein the sacrificing the at least the portion of the sacrificial tooling element is using a high-pressure water stream to destroy the portion of the sacrificial tooling element.

In another example embodiment, the method may be performed wherein the sacrificing the at least the portion of the sacrificial tooling element is using an acid to destroy the portion of the sacrificial tooling element.

In another example embodiment, the method may be performed wherein the sacrificial tooling element has two portions that are sacrificial.

In another example embodiment, the method may be performed wherein the forming at least one component of a plug component on an exterior of the sacrificial tooling element is performed by winding a composite material around the sacrificial tooling element.

In another example embodiment, the method may be performed wherein the composite material is a fiberglass material.

In another example embodiment, a sacrificial tool component is disclosed, comprising a cone, a first portion connected to the cone, and a sacrificial tooling portion connected to the first portion. The sacrificial tool component may further comprise a second portion connected to the sacrificial tooling portion and a third portion connected to the second portion. The sacrificial tool component may further comprise a second sacrificial portion connected to the third portion and a fourth portion connected to the second sacrificial portion. The sacrificial tool component may further comprise a flange connected to the fourth portion.

In another example embodiment, the sacrificial tool component may be configured wherein the sacrificial tool portion has an elongated tapered flange configuration.

In another example embodiment, the sacrificial tool component may be configured wherein the second sacrificial portion is configured as an elongated tapered flange configuration with segments.

In one example embodiment, a method is disclosed. The method may comprise providing a tooling element that is capable of disassembly. The method may also comprise forming at least one component of a plug component on an exterior of the tooling element. The method may also comprise disassembling the tooling element such that portions of the tooling element may be removed from the plug component. The method may also comprise removing each of the tooling elements from the plug component.

In one example embodiment, the method may be performed wherein the tooling element is composed of at least two elements.

In another example embodiment, the method may further comprise finishing an exterior surface of the plug component prior to removing each of the tooling elements from the plug component.

In another example embodiment, the method may further comprise finishing an exterior surface of the plug component after removing each of the tooling elements from the plug component.

In another example embodiment, the method may be performed wherein the composite material is a fiberglass material.

In another example embodiment, a method is disclosed. The method may comprise, providing a sacrificial tooling element and forming at least one component of a plug component on an exterior of the sacrificial tooling element. The method may also provide for sacrificing at least a portion of the sacrificial tooling element.

In another example embodiment, the method may further comprise removing at least a portion of the sacrificial tooling element.

In another example embodiment, the method may be performed wherein the sacrificing of the portion of the sacrificial tooling element is performed through at least one of mechanical destruction and acid destruction.

In another example embodiment, an arrangement, is disclosed. The arrangement may comprise a body having a longitudinal axis. The arrangement may be configured with a lower slip system located on the body, the lower slip system having at least a first set of six slips and at least six wedges configured to interact with a scalloped portion, wherein the slips are configured to shear from an associated wedge of the at least six wedges at a pre-determined shear force. The arrangement may also be configured with an upper slip system located on the body, having a taper, a second set of at least six slips and at least six wedges, the at least six wedges configured to interact with the taper, wherein the slips are configured to shear from an associated wedge of the at least six wedges at a pre-determined shear force.

In another example embodiment, the arrangement may further comprise at least one button configured to engage an inside of a wellbore on each of the first set of six slips and the second set of six slips.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method, comprising:
providing a sacrificial tooling element;
forming at least one component of a plug component on an exterior of the sacrificial tooling element;
forming an exterior source of the at least one component of the plug;
sacrificing at least a portion of the sacrificial tooling element; and
removing the sacrificial tooling element from the at least one component.

2. The method according to claim 1, wherein the sacrificing at least a portion of the sacrificial tooling element is accomplished by using a high-pressure water stream to destroy the portion of the sacrificial tooling element.

3. The method according to claim 1, wherein the sacrificing at least a portion of the sacrificial tooling element is accomplished by using an acid to destroy the portion of the sacrificial tooling element.

4. The method according to claim 1, wherein the sacrificial tooling element has two portions that are sacrificial.

5. The method according to claim 1, wherein the forming at least one component of a plug component on an exterior of the sacrificial tooling element is performed by winding a composite material around the sacrificial tooling element.

6. The method according to claim 5, wherein the composite material is a fiberglass material.

7. A tool component, comprising:
a cone;
a first portion connected to the cone;
a sacrificial tooling portion connected to the first portion;
a second portion connected to the sacrificial tooling portion;
a third portion connected to the second portion;
a second sacrificial portion connected to the third portion;
a fourth portion connected to the second sacrificial portion; and
a flange connected to the fourth portion.

8. The tool component according to claim 7, wherein the sacrificial tool portion has an elongated tapered flange configuration.

9. The tool component according to claim 7, wherein the second sacrificial portion is configured as an elongated tapered flange configuration with segments.

10. A method, comprising:
providing a tooling element that is capable of disassembly;
forming at least one component of a plug component on an exterior of the tooling element;
disassembling the tooling element such that portions of the tooling element may be removed from the plug component; and
removing each of the tooling elements from the plug component.

11. The method according to claim 10, wherein the tooling element is composed of at least two elements.

12. The method according to claim 10, further comprising:
finishing an exterior surface of the plug component prior to removing each of the tooling elements from the plug component.

13. The method according to claim 10, further comprising:
finishing an exterior surface of the plug component after removing each of the tooling elements from the plug component.

14. The method according to claim 10, wherein the forming at least one component of a plug component is performed by winding a composite material around the sacrificial tooling element.

15. The method according to claim 14, wherein the composite material is a fiberglass material.

16. A method, comprising:
providing a sacrificial tooling element;
forming at least one component of a plug component on an exterior of the sacrificial tooling element; and
sacrificing at least a portion of the sacrificial tooling element.

17. The method according to claim 16, further comprising:
removing at least a portion of the sacrificial tooling element.

18. The method according to claim 16, wherein the sacrificing of the portion of the sacrificial tooling element is performed through at least one of mechanical destruction and acid destruction.

19. An arrangement, comprising:
a body having a longitudinal axis;
a lower slip system located on the body, the lower slip system having at least a first set of six slips and at least six wedges configured to interact with a scalloped portion, wherein the slips are configured to shear from an associated wedge of the at least six wedges at a pre-determined shear force; and
an upper slip system located on the body, having a taper, a second set of at least six slips and at least six wedges, the at least six wedges configured to interact with the taper, wherein the slips are configured to shear from an associated wedge of the at least six wedges at a pre-determined shear force.

20. The arrangement according to claim 19, further comprising:
at least one button configured to engage an inside of a wellbore on each of the first set of six slips and the second set of six slips.
